(19) United States
(12) Patent Application Publication
(10) Pub. No.: US 2010/0161511 A1
(43) Pub. Date: Jun. 24, 2010

(54) System and Method for Analyzing Operational Risk and Performance of Real Rental Property

(76) Inventor: Jesse Holland, Niskayuna, NY (US)

Correspondence Address: LAW OFFICE OF JAY R. YABLON, 910 NORTHUMBERLAND DRIVE, SCHENECTADY, NY, 12309-2814, US

(21) Appl. No.: 12/715,346

(22) Filed: Mar. 1, 2010

Related U.S. Application Data
(60) Provisional application No. 61/157,544, filed on Mar. 4, 2009.

(51) Int. Cl. G06Q 50/00; G06Q 40/00; G06Q 10/00

(52) U.S. Cl. 705/36 R; 705/307; 705/314; 705/348; 705/418

(57) ABSTRACT

A computerized method and associated computerized apparatus and product by process for determining a default risk for a given real rental property, comprising: providing computerized property data for a plurality of real rental properties comprising at least a rental price and a square footage for each said real rental property in the plurality of real rental properties; and via a user interface and computerized processing and computerized storage: calculating a rent per square foot for each of said plurality of real rental properties, including the given real rental property; calculating a property gauge score for each real rental property in the plurality of real rental properties including for said given real rental property; and determining the default risk for the given real rental property by comparing the property gauge score for the given real rental property to the property gauge scores for the remaining real rental properties in the plurality of real rental properties.

### CROSS REFERENCE TO RELATED APPLICATIONS

This application claims priority of pending provisional application U.S. 61/157,544 filed Mar. 4, 2009, which is hereby incorporated in full, by reference.

### BACKGROUND OF THE INVENTION

Data collection pertaining to various types of real rental property is by no means unusual in the rental industry. However, used in a sophisticated way, information contained in rental property databases can be utilized to develop relative information on the performance of individual properties, owners or managers when compared to the markets in which they do business, with understanding that a “market” may be defined differently in different circumstances but will generally include at least a regional/geographic component.

Particularly during economic downturns, when foreclosures of real properties tend to increase, this information can be very helpful to identify which properties may be running a risk of default, and why, and to take steps to remedy the situation before it becomes more severe and a property does need to go into default.

Applicant began collecting multifamily housing information in 2001 and collects new information and updates existing databases every six months, though it would be apparent to someone of ordinary skill to vary this collection and update frequency. While this database was originally developed as a client service, applicant realized during the recent economic downturn that the information contained in the databases could also be utilized in a novel and inventive manner to provide relative information on the performance of individual properties, owners or managers when compared to the markets they do business in, and that this could in turn serve to identify real properties with the potential for loan default. This enables various steps to be taken to avert such a prospect before it becomes irreversible. This is a valuable need in the art which appears not to be met at present.

The closest prior art which applicant is aware of, none of which anticipates or renders obvious applicant's invention, includes the following: U.S. Pat. No. 7,266,524 B1 appears to be a software program and system for isolating risk among different bonds. U.S. Pat. No. 7,346,570 B2 appears to involve updating the credit rating of structured securities. U.S. Pat. No. 7,353,198 B2 appears to generate and manage a generic mortgage backed securities index where the index utilizes bonds. U.S. Pat. No. 7,403,919 B2 appears to be for structuring and operating a credit index to determine credit liquidity. U.S. Pat. No. 7,415,471 B1 appears to provide commercial mortgage loan servicing documentation, and improve the efficiency of document collection and storage. U.S. Pat. No. 7,440,921 B1 appears to be for evaluating a real estate transaction based on preliminary date and improving time factors. U.S. Pat. No. 7,454,383 B2 appears to be a financial model for assessing a loan portfolio for variances in loan portfolios. This is based on financial factors with no market or operational considerations. U.S. Pat. No. 7,464,052 B1 appears to be for managing investment portfolio risk on a computer system using a plurality of parameters. U.S. Pat. No. 7,469,227 B2 appears to disclose a retail risk related evaluation of loan portfolios and the generation of various potential scenarios. There is no evaluation of commercial risk and the methodology used is very different. U.S. Pat. No. 7,480,632 B2 appears to disclose a process for allocating specific assets from a pool of assets to secure liability.

US 2002/00355330 A1 appears to disclose a credit review analysis of asset backed securities and securities management. US 2003/0105708 A1 appears to disclose an analysis of a commercial mortgage back security (CMBS) when another mortgage loan is added to the portfolio. US 2004/0153330 A1 appears to be for evaluating default and foreclosure loss risk based on factors such as home price trend for MSA where real estate is located and loan terms, and evaluates homes rather than rental property for which the default indicators are very different. US 2003/0110045 A1 appears to disclose an analysis of commercial mortgage back security (CMBS) and is a continuation of US 2003/0105708 A1. US 2004/0158520 A1 appears to be for evaluating and monitoring collateralized debt obligations. US 2006/0059073 A1 appears to assess a loan's financial risk due to variations occurring in the underwriting of a loan by analyzing financial factors as part of the underwriting process. US 2006/0242047 A1 appears to be for rating asset backed securities utilizing various data sources into a model which, when applied to a loan portfolio, can reduce the amount of credit enhancement required. US 2006/0277141 A1 appears to disclose accelerated collateral review and analysis of appraisal reports. US 2007/0168272 A1 appears to be for managing collateralized obligations to satisfy predetermined investment rating requirements. US 2008/01133427 A1 appears to be for evaluating collateralized debt obligations. It utilizes a modeling scenario for default or loss rates. US 2008/0243680 A1 appears to use a modeling approach utilizing various data sources that describes a consumer's spending capability. When applied it can reduce credit enhancement required for asset backed ratings. US 2008/0249809 A1 appears to disclose a system for monitoring collateralized security underlying a set of loans.

None of the foregoing, separately or in combination, anticipates or render obvious, applicant's invention disclosed herein. It remains is desirable to have a system which enables properties in a given, preselected market to be compared with one another, in a simple fashion, without complex models, based on actual market factors, so that risk can be identified, and steps taken to remediate those risks, before a property goes into default.

### SUMMARY OF THE INVENTION

Disclosed herein is a computerized method and associated computerized apparatus and product by process for determining a default risk for a given real rental property, comprising: providing computerized property data for a plurality of real rental properties including said given real rental property, the computerized property data comprising at least a rental price and a square footage for each said real rental property in the plurality of real rental properties including the given real rental property; and via a user interface and requisite computerized processing and computerized storage: calculating a rent per square foot for each of said plurality of real rental properties, including the given real rental property; calculating a property gauge score for each real rental property in the plurality of real rental properties including for said given real rental property, by comparing the rent per square foot for each said real rental property in the plurality of real rental properties to a rent per square foot of an aggregate including the other real rental properties in the plurality of real rental properties; and determining the default risk for the given real rental property by comparing the property gauge score for the given real rental property to the property gauge scores for the remaining real rental properties in the plurality of real rental properties.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a flowchart summarizing a data flow for a property already existing in the underlying Property Gauge database.

FIG. 2 is a flowchart summarizing a data collection flow for a new property not already existing in the underlying Property Gauge database.

FIG. 3 is a flowchart summarizing the Property Gauge scoring process for evaluating properties.

FIG. 4 is a flowchart summarizing how the Property Gauge system arrives at a baseline score for properties.

FIG. 5 illustrates a distribution curve containing the Property Gauge Scores for a plurality of properties, and some exemplary ranges used to determine default risk for a given property as well as actions to be taken with respect to that property.

FIG. 6 illustrates an actual computerized data form which shows illustrative data for a given individual rental property in the Property Gauge database.

### DETAILED DESCRIPTION

The Property Gauge™ is a system and method for analyzing performance of multifamily, retail property, office building, warehouse or other commercial entities. The uniqueness of the property gauge rests in its scoring system which identifies potentially poorly performing assets (properties) due to either operational deficiencies or financial distress. The invention centers around both the automated scoring system and the business method of subsequent operations recommended and taken as a result of initial scoring. While subsequent operations such as onsite inspection and training are not themselves unique, when utilized in combination with the automated property gauge asset scoring system, they do define a novel and non-obvious invention.

Property gauge comprises a computerized method and apparatus for determining a default risk for a given real rental property. Typically, a loan or mortgage would define what is meant by default and the score is the identifier for the potential default. In contrast, the specific purpose of this invention is to identify property that is at risk for loan/mortgage foreclosure prior to such action, in an automated, bulk fashion, so that remedial methods can be undertaken to avoid such finality. The term “real property” may include multifamily residential rental units, or any other property rented for occupancy by individual members of the general public or by organizations.

The property gauge score for an individual property is based on historical information collected for the property, and requires no unique modeling. It is strictly based, in a simple manner, on objective market factors. Rental information is updated every six months, and includes the rental price per square foot which is a baseline measure for rental real estate. This baseline measure can optionally though preferably be adjusted based on a variety of rent adjustment factors, unit amenity adjustment factors, and property amenity adjustment factors. Then, as detailed further below, a property gauge score is developed for each real rental property by comparing its baseline or adjusted price per square foot with those of other properties similarly situated, either geographically, or on the basis of any other classification which makes sense in the rental market for real property.

The actual property gauge score a given real rental property amidst a plurality of similarly situated real rental properties (properties in a pertinent, preselected “pool”) is obtained by comparing the baseline or adjusted rent per square foot for each said real rental property in the pool to the baseline or adjusted rent per square foot of an aggregate of the other real rental properties in the pool. Then, the default risk for the given real rental property is calculated by comparing the property gauge score for that given real rental property to the property gauge scores for the remaining real rental properties in the plurality of real rental properties, and placing it on an overall “bell” or similar curve.

A few specific examples would be helpful: Let denote the rent (baseline or adjusted) per square foot for a given property. Let A denote the average aggregate rent (respectively, baseline or adjusted) per square foot for a given property all of the properties in the pertinent “pool,” preferably including the given property in question. (Alternatively, A may denote a mean of the aggregate rents.) Let S denote the overall scale on which a property is to be scored. For example, not limitation, if S=1000, that means that each property in the pool is to be graded on a scale of 1 to 1000, with 500 (½×1000) being an “average” score. If PGS denotes the “Property Gauge Score” for any given property, then:

$$PGS = \frac{R}{A} \times \frac{1}{2} S \qquad ( 1 )$$

For example, using baseline (unadjusted) rent per square foot, if a given property rents for R=$1.20 per square foot and the average per square foot rental in the pertinent preselected pool is A=$1.35 per square foot, then with S=1000, the property gauge score of that property will be PGSI=444.4 out of 1000. If another property in the same market sells for R=$1.70 per square foot, then the gauge score of that property will be 629.6 out of 1000.

Thus is will be seen that the Property Gauge Score for said given real rental property is proportional (in this exemplary illustration by the proportionality constant ½S) to a ratio (R/A) of the rent per square foot for said given real rental property (R), over the average rent per square foot (A) of the aggregate of said other real rental properties in said plurality of real rental properties.

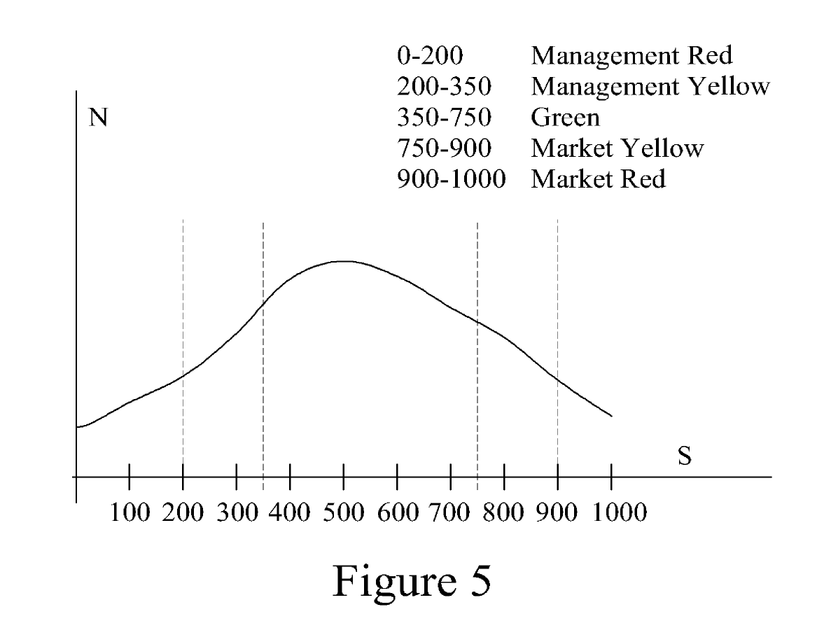

This score, as set forth above, which is clearly developed in relation to a real, functioning market rather than on the basis of any abstract principle or model, may be ascertained for each and every property in the pertinent pool. Thus, continuing with the S=1000 scale, one may, for example, have one property with a Property Gauge Score of 187, another with 350, another with 435, another with 502, another with 612, another with 787, another with 917, etc. And, in a given pool, there may be hundreds or thousands of properties or more, so the scores of all the properties can be plotted onto a numbers distribution curve which statistically is expected to resemble a “bell curve,” such as that shown in FIG. 5.

Once the Property Gauge Scores for all the properties in a pool are distributed such as in the numbers distribution curve exemplified in FIG. 5, which uses S=1000 by way of example not limitation, with the vertical axis representing “numbers” of properties that show up at each score, one uses the location of any given property on that distribution to determine the default risk.

Based on applicant's experience in valuing an monitoring properties, and by way of non-limiting example, one may designate any property with a score of 0-200 as “management red,” indicating a serious problem with the property which has caused that property to be renting at 40% or less (200/500) of the average rent per square foot for similarly-situated properties, and which is an indicator of a high degree of default risk based on some management/operational issue related to the property. A property in the range of 200 to 350 (between 40% and 70% of average) indicates a cautionary “management yellow” which means the property should be monitored more closely over time, but does not yet signal an imminent default risk. A property in the range of 350 to 750 is considered “green,” with no special action required and no particular imminent worry of default. A score in the 750 to 900 range (a property renting at 150% to 180% of the market average) indicates a cautionary “market yellow” that means that the property should be monitored more closely over time because of market conditions which render it significantly overpriced, while any score over 900 (180% of market average) signal imminent default risk based on market conditions due to low likelihood that the property will be able to compete in the market and draw new tenants, given its extreme overpricing in relation to like properties.

While the above exemplary “ranges” are preferred and have been found by the inventor to make economic and business sense, it should be made clear that these ranges are by no means exclusive, and it is to be understood within the scope of this disclosure and its associated claims that other approaches for grouping the results and consequent follow up are equally within the scope of this disclosure and its associated claims. For example, it would be possible within the scope of this invention to perform statistical analysis on all of the property scores represented by the distribution curve of FIG. 5, and to find which properties deviate from the mean or average by 1, or 1.5, or 2, etc., standard deviations, and to classify properties based on their exceeding some predetermined standard deviation from the mean, either above or below.

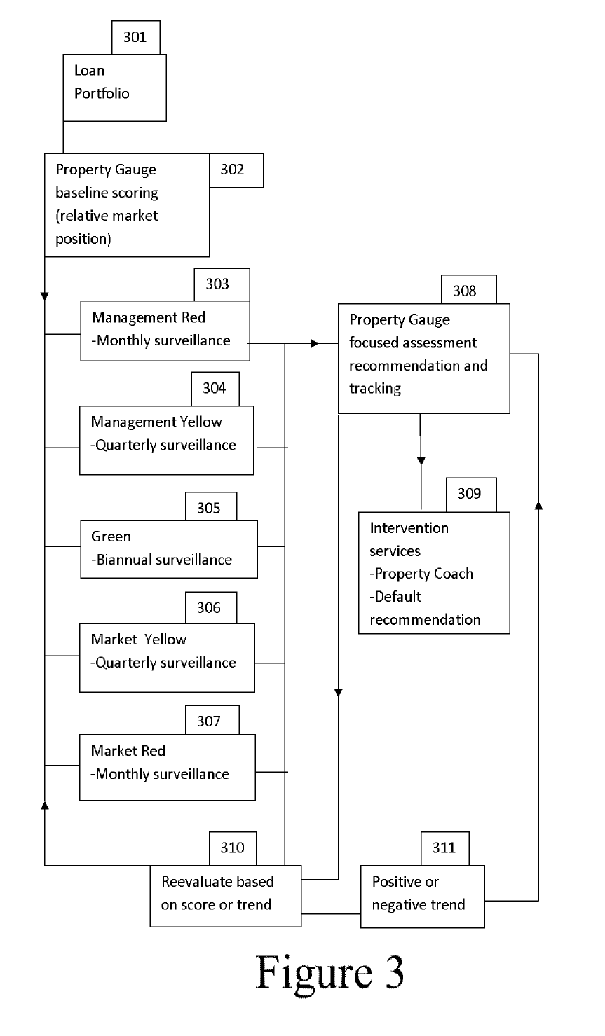

The scores noted above, if they are too far from the mean or average, do in fact signal either a “management” or “operational” problem for a property with a rent per square well under what is typical for the aggregate pool of properties, or a “market” problem for a rent per square well above the aggregate. This is discussed in further detail below, in connection with boxes 303 to 307 of FIG. 3.

As mentioned earlier, the rent per square foot used in equation (1) may be the baseline rent per square foot (the amount of the check written out each month by a tenant), or, preferably, it can be an adjusted rent per square foot taking into account certain rent adjustment factors, unit amenity adjustment factors, and/or property amenity adjustment factors. The rental adjustment factors comprise an array of factors which effectively decrease (or in some cases increase) the baseline rent.

For example not limitation, the rent adjustment factors may comprising at least one of: rental discounts, if any; electrical service included in the rental price, if any; cable television service included in the rental price, if any; water service included in the rental price, if any; heat service included in the rental price, if any; cooking gas service included in the rental price, if any; internet service included in the rental price, if any; and garbage removal service included in the rental price, if any. If one or more of these foregoing, or like benefits, are provided for payment of the baseline rent, then these serve to reduce the baseline rent, and so lead to a rent “adjustment” used to calculate the rent per square foot. Thus, for an apartment with an $800 per month rent for 800 square feet (baseline: $1 per square foot per month) which includes cable television and internet service valued at $60 per month with no extra charge, the adjusted rent becomes $740 per month, and so the adjusted rent per square foot is $0.925 per square foot.

This approach, of course, depends in part on establishing what is “baseline” and what is an “adjustment.” Thus, if “baseline” is defined to contain electricity and gas, and if neither of these are included in the rent but are separately paid by the tenant, then the rent per month would be adjusted upward, before the adjusted rent per square foot is calculated. Thus, it is to be understood within the scope of this disclosure and its associated claims that the adjusted rent per square foot may be calculated based on either an increase or a decrease from the actual “baseline” rent that is paid, depending upon is established as the “baseline” in any particular embodiment of the invention. The point is to make sure that once properties are compared to one another in the aggregate and the distribution curve is developed, the comparison among properties is “apples to apples.”

This may also mean, in any given situation, that for at least one property in the plurality of real rental properties, the adjusted rent per square foot is equal to the (baseline) rent per square foot with an adjustment equal to zero. This would be for a property that includes whatever is regarded as “baseline” and does not include anything that is not regarded as “baseline.” Clearly, “baseline” is most readily established to be equal to the size of the check that must be paid each month, but it is important to be clear that this process can be varied with the scope of the invention whereby “baseline” is established in some other fashion as well.

In addition to the foregoing rent adjustment factors, there may also be unit amenity adjustment factors, and property amenity adjustment factors. The unit amenity adjustment factors may comprise, for example not limitation, at least one of: a dishwasher included in the rental price, if any; a microwave included in the rental price, if any; a washer/dryer included in the rental price, if any; a garage included in the rental price, if any; window coverings included in the rental price, if any; a fireplace included in the rental price, if any; vaulted ceilings included in the rental price, if any; a skylight included in the rental price, if any; bay windows included in the rental price, if any; granite countertops included in the rental price, if any; and an air conditioner included in the rental price, if any.

Similarly, the property amenity adjustment factors comprising at least one of: a clubhouse included in the rental price, if any; a laundry room included in the rental price, if any; a fitness center included in the rental price, if any; a pool included in the rental price, if any; sports activities included in the rental price, if any; a playground included in the rental price, if any; an elevator included in the rental price, if any; a concierge included in the rental price, if any; a business center included in the rental price, if any; and security service included in the rental price. Clearly, both the unit amenity adjustment factors and the property amenity adjustment factors can be used to adjust the rent per square foot upwards or downwards, and facilitate further “apples to apples” comparison among property in developing their Property Gauge Scores.

In addition to all that has been mentioned so far, other elements which may be considered in establish and adjusted rent per square foot for the properties in question include, but are not limited to: demographic data, such as number of units, property age and repair state, floor plans, neighborhood quality, services provided by the local municipal entity (e.g., trash removal), etc.

Reference has been made to the plurality of real properties from and for which the Property Gauge Scores are developed, which properties may be thought of as a “pool” of properties similarly situated based on a one or more pertinent factors the foremost of which is geographic location. However, these pools may be based on market, county, region, state or any other consideration which makes sense on some economic basis. For example: all two-bedroom apartments; all properties rented to college students near a university; all properties rented to the public for seasonal usage (week during the summer, during the winter, etc.)

The automated development of a property gauge score, is not the end of the process but rather the beginning, representing the technical foundation for combination with an overall various business method, or those properties which fall within the “acceptable” “green” range of the bell curve (where the score itself is not suggesting either operational or financial issues) the recommendation would be a rescore at some time point beyond the next update for the defined area. For those who fall within the “yellow” or “red” ranges on management issues, based on whatever approach is used for determining deviation from the mean, the business method recommendation would generally include onsite assessment and perhaps a training program to improve property management. For those who fall within the “yellow” or “red” ranges on market issues, the concern is the owner's ability to maintain such an elevated level of rent. Thus, it becomes important as a business method to monitor the market (rather than the management) closely for changes (up or down), and to monitor the property closely to make sure things do not change, such as a drop in rent level because the property rent overshot the market, or excessive vacancy.

A specific property's score can be different if another defined area is utilized. For example, a property compared to an entire state's database in the aggregate, could score differently than if it was compared to a smaller regional (and perhaps similar in demographic characteristics) database. Thus, the purpose for which a particular analysis is run is important in determining the plurality of properties which comprise the “pool” under consideration.

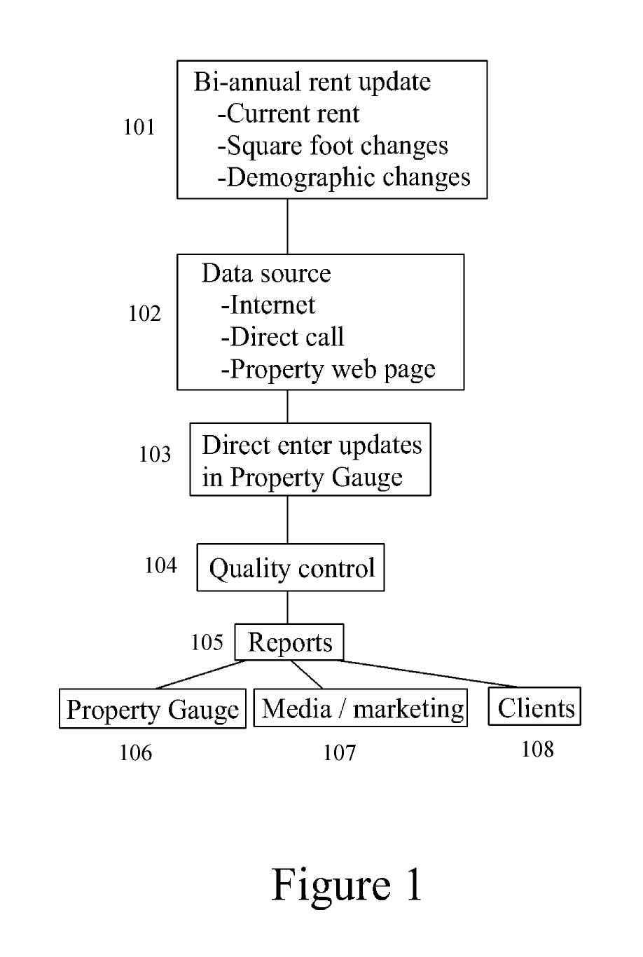

Referring now to the drawings, FIG. 1 illustrates the information collected to update a property's information for individual properties already included in the database. This includes any changes to base rent for each unit type included, updates to the accuracy of square foot information and any changes to concessions made by the owner/manager for required data elements. Any changes to demographic information would also be collected at this time. At 101, rents, square footage and demographic information is updated periodically, for example, every six months, to maintain currency. At 102 information for the updates are obtained from internet sources, direct calls to the property being updated or from the property's own website. At 103 updated information is directly entered into Property Gauge without using any intermediate source such as a worksheet. At 104 quality assurance techniques are applied to ensure accuracy of the information and to ensure that data surveyors are collecting the information accurately. At 105 various reports are generated utilizing the updated information. Boxes 106 to 108 represents uses for the updated information, which includes the Property Gauge Score at 106 which is the main subject of the invention.

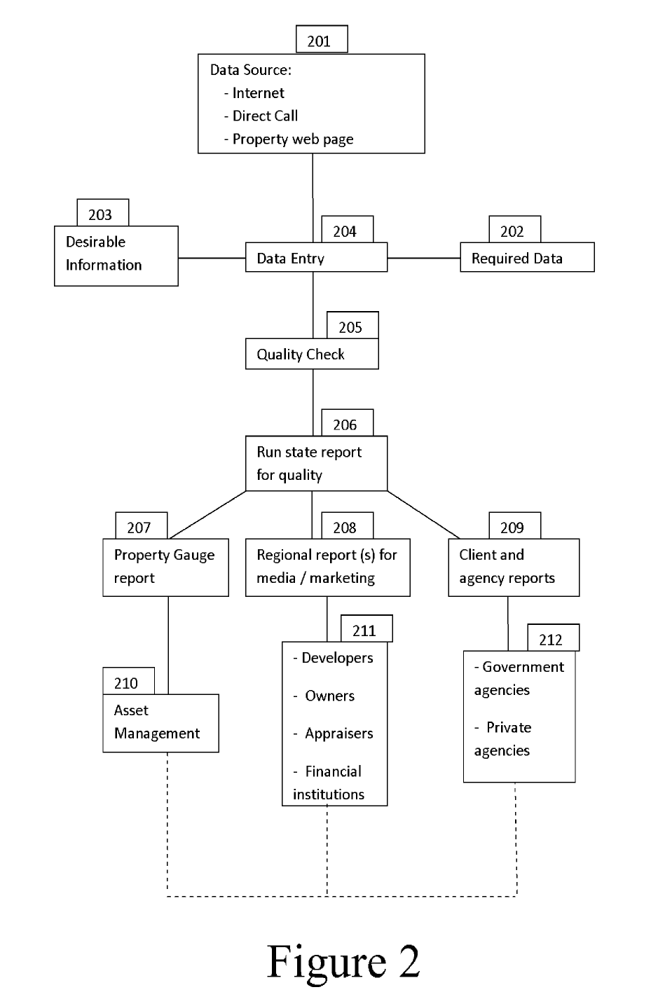

FIG. 2 illustrates the information collected for the initial inclusion of a property in a database. The information includes name, address including county, year built, number of units, telephone numbers including toll free, building style information, owner including address and telephone numbers, management company if different than owner, unit type information (bedrooms, baths, extra room, square footage and rent for each different unit type being utilized), information source, rent concessions, website address, community amenities, unit amenities, utility information and data collector name. Some of these items are standard background data, but included here are the information items such as rental and square footage and amenities that are inputs for developing the property gauge score.

At 201, rents, square footage and demographic information is collected for a property that meets the parameters for inclusion in the database but has not previously been included. This may include information for a new database being established in a new region, or for a property in an existing database that was not previously included due to lack of required data elements, e.g., for a newly constructed property. At 202, represented are those data elements which are required for a property if it is to be included in a database. These include name, complete address number of apartment units, telephone numbers, unit types, rent, square footage, rent concessions and data surveyor who collected the information. Box 203 represents desirable but optional information not absolutely needed for a successful inclusion in the database. This includes year built, building style (siding, roof and number of floors), owner and/or manager, call source, website address, managers name, community amenities, unit amenities and utility information. At 204, newly obtained property information is directly entered into Property Gauge without utilizing any intermediate source such as a worksheet. At 205, quality assurance techniques are applied to ensure accuracy of the information and that data surveyors are collecting the information accurately. Box 206 represents that when a new state database is completed, quality reports are generated and any outlier information is verified or corrected before a database is placed in use. Box 207 represents reports that can be generated for the Property Gauge Scoring System. Box 208 represents reports that are generated through for use by media and marketing sources (e.g. via Realhound®). Box 209 represents reports generated by either Property Gauge Scoring System or for clients/customers or government agency use. At 210, information is represented from the scoring system that can be utilized by various sources in assessing the quality of the loans in a portfolio or loans being considered for approval (generally referred as asset management). At box 211 are represented the most common users of the regional or other defined geographic area reports in asset management activity. Box 212 shows the most common users of client and agency reports in asset management activity.

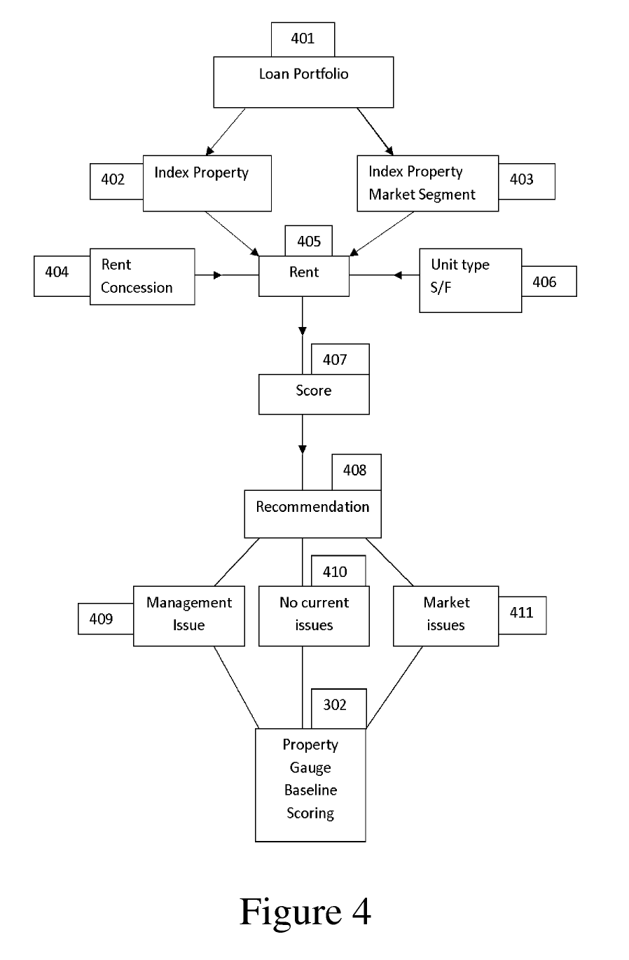

FIG. 3 illustrates the Property Gauge Scoring System's outcomes in the form of relative market position and how judgments (recommendations) are made and follow up actions taken, based on the scoring system. Box 301 represents a single loan or a group of loans co-mingled for assessment. Box 302 illustrates the Property Gauge baseline scoring system which can define a property's relative market position in comparison to other properties in a given market. This box is expanded further in FIG. 4, which describes the scoring system in further detail.

Boxes 303 to 307 illustrate the scoring system is defined in terms of five (5) potential outcomes. It is to be understood that these are exemplary, not limiting, and that more categories or less categories can also be practices within the scope of this invention, and that the scoring criteria for placing a given property in any particular category can be varied within the scope of this disclosure and its associated claims. In reviewing these categories, it is also helpful to refer to FIG. 5.

Box 303 illustrates properties scored to be “Management Red.” Those properties are in serious distress due to the inability of the owner/manager to establish and follow generally accepted and proven methods to operate their property. At a minimum, it is preferred that monthly surveillance and reporting would be made to the lien holder. Box 304 illustrates properties scored to be “Management Yellow.” These properties represent a less serious but not an inconsequential inability of the owner/manager to consistently follow generally accepted and proven methods of property operation. A recommendation of quarterly surveillance is preferred. At box 305, “Green” represents those properties that are being operated in generally accepted operational and financial terms and do not currently represent a significant risk to the lien holder. Box 306 designates “Market Yellow.” These properties represent a less serious but not inconsequential situation where market conditions are causing or could cause an owner to be unable to meet their financial obligations. This is without regard to the owner's ability to operate the property within generally accepted standards. Box 307, “Market Red,” represents a serious situation where an owner/manager may be unable to meet their financial obligations, notwithstanding their ability to operate the property within generally accepted standards. In this scenario it would be expected that changes in the market could cause the loan portfolio to be unable to generate adequate income to meet the loan portfolio's fixed expenses.

Box 308 represents outcomes from the scoring system that can be recommended and undertaken to improve the property's operating condition. Box 309 represents intervention services that can be provided to improve the operational or financial aspects of a given property or a final recommendation that the current loan portfolio is not salvageable under the current loan terms. Box 310 represents subsequent periodic applications of the scoring system. Box 311 represents improvement or further decline over time, of a property's operational or financial condition.

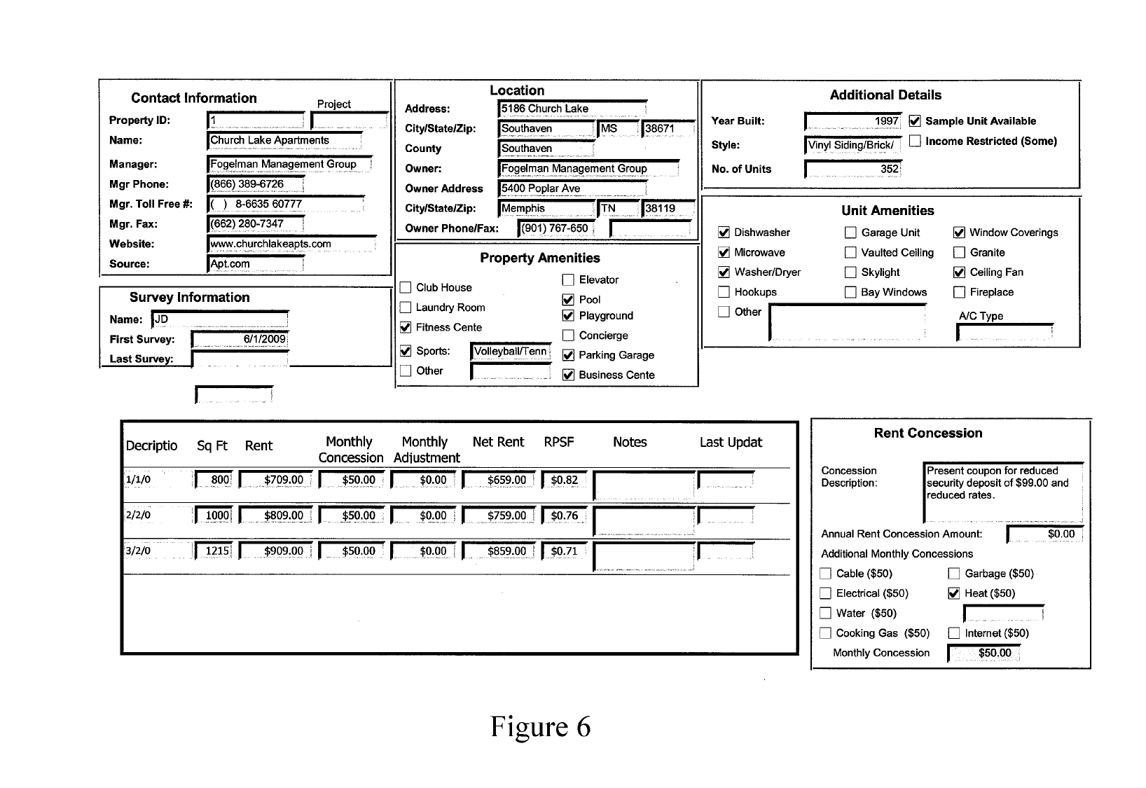

FIG. 4 describes the components of the Property Gauge Scoring system, and is an expanded view of box 302 of FIG. 3. The basic data elements from the database utilized here include rent, square footage, unit types and rent concessions as a value (blended score) compared to the entire market area. See also FIG. 6 which shows these data elements in a data entry/display form. At box 401, a single loan or group of loans co-mingled for assessment are represented. Box 402 indicates the specific property or group of properties under review. Box 403 indicates the specific market represented by the property or group of properties under review, i.e., the particular “pool” comprising a plurality of real rental properties. Box 404 represents adjustment for concessions made in the marketplace (such as cost of amenities, free rent, payment of some or all of utilities or other concessions made by the owner). Box 405 represents actual rent paid for each unit type. Box 406 represents actual square footage for each unit type. Box 407 represents automated calculation of the Property Gauge score, via equation (1) set forth and discussed earlier. At box 408, actual business recommendations are made based on the application of a Property Gauge score. Box 409 represents scores that fall within the operational aspects of a property, i.e., that flag management issues in the “red” or “yellow” zone.

Box 410 represents a property without apparent operational or financial issues, defined as a “green” property. Box 411 represents scores that fall with the “red” or “yellow” zone based on market aspects of a property, notwithstanding the owners/managers ability to operate within generally accepted standards. Box 302 references to the Property Gauge score located at Box 302 in FIG. 3.

FIG. 5, discussed somewhat at length already, illustrates the distribution curve containing the Property Gauge Scores for a plurality of properties, and some exemplary ranges used to determine default risk for a given property as well as actions to be taken with respect to that property.

FIG. 6 illustrates an actual computerized data form which shows illustrative data for a given individual rental property in the Property Gauge database. It will be seen that this form contains all of the information that goes into the formulation or Property Gauge Scores as previously described, including square footage, rent, and various rent concessions and other amenities which go into determining an adjusted rent per square foot used to calculate the property gauge scores.

The knowledge possessed by someone of ordinary skill in the art at the time of this disclosure is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A computerized method for determining a default risk for a given real rental property, comprising:
providing computerized property data for a plurality of real rental properties including said given real rental property, said computerized property data comprising at least a rental price and a square footage for each said real rental property in said plurality of real rental properties including said given real rental property; and
via a user interface and requisite computerized processing and computerized storage:
calculating a rent per square foot for each of said plurality of real rental properties, including said given real rental property;
calculating a property gauge score for each real rental property in said plurality of real rental properties, by comparing the rent per square foot for each said real rental property in said plurality of real rental properties to a rent per square foot of an aggregate including the other real rental properties in said plurality of real rental properties; and
determining said default risk for said given real rental property by comparing the property gauge score for said given real rental property to the property gauge scores for said remaining real rental properties in said plurality of real rental properties.

2. The method of claim 1, wherein said rent per square foot is an adjusted rent per square foot which is calculated to adjust for at least one of: rent adjustment factors; unit amenity adjustment factors; and property amenity adjustment factors.

3. The method of claim 1, wherein said property gauge score for said given real rental property is proportional to a ratio of said rent per square foot for said given real rental property, over said rent per square foot of said aggregate of said other real rental properties in said plurality of real rental properties.

4. The method of claim 3, wherein said property gauge score, denoted by PGS, is given by:
$$PGS = \frac{R}{A} \times \frac{1}{2} S ,$$
where denotes a rent per square foot for said given property, A denotes an aggregate average or mean rent for all of said plurality of real rental properties, and S denotes an overall scale on which said property is to be scored.

5. The method of claim 2, wherein said property gauge score for said given real rental property is proportional to a ratio of the adjusted rent per square foot for said given real rental property, over the adjusted rent per square foot of said aggregate of said other real rental properties in said plurality of real rental properties.

6. The method of claim 5, wherein said property gauge score, denoted by PGS, is given by:
$$PGS = \frac{R}{A} \times \frac{1}{2} S ,$$
where R denotes a rent per square foot for said given property, A denotes an aggregate average or mean rent for all of said plurality of real rental properties, and S denotes an overall scale on which said property is to be scored; and wherein
said R comprises said adjusted rent per square foot and said A comprises said adjusted rent per square foot of said aggregate.

7. The method of claim 2, said computerized property data further comprising said rent adjustment factors comprising at least one of: rental discounts, if any; electrical service included in said rental price, if any; cable television service included in said rental price, if any; water service included in said rental price, if any; heat service included in said rental price, if any; cooking gas service included in said rental price, if any; internet service included in said rental price, if any; and garbage removal service included in said rental price, if any; wherein:
said rent per square foot is an adjusted rent per square foot which is calculated to adjust for said rent adjustment factors.

8. The method of claim 2, said computerized property data further comprising said unit amenity adjustment factors comprising at least one of: a dishwasher included in said rental price, if any; a microwave included in said rental price, if any; a washer/dryer included in said rental price, if any; a garage included in said rental price, if any; window coverings included in said rental price, if any; a fireplace included in said rental price, if any; vaulted ceilings included in said rental price, if any; a skylight included in said rental price, if any; bay windows included in said rental price, if any; granite countertops included in said rental price, if any; and an air conditioner included in said rental price, if any; wherein:
said rent per square foot is an adjusted rent per square foot which is calculated to adjust for said unit amenity adjustment factors.

9. The method of claim 2, said computerized property data further comprising said property amenity adjustment factors comprising at least one of: a clubhouse included in said rental price, if any; a laundry room included in said rental price, if any; a fitness center included in said rental price, if any; a pool included in said rental price, if any; sports activities included in said rental price, if any; a playground included in said rental price, if any; an elevator included in said rental price, if any; a concierge included in said rental price, if any; a business center included in said rental price, if any; and security service included in said rental price, if any; wherein:
said rent per square foot is an adjusted rent per square foot which is calculated to adjust for said property amenity adjustment factors.

10. The method of claim 2, wherein for at least one property in said plurality of real rental properties, said adjusted rent per square foot is equal to said rent per square foot with an adjustment equal to zero.

11. The method of claim 1, said computerized property data further comprising unit status factors comprising at least one of: an age of said real rental property; a repair state of said real rental property; a floor plan of said real rental property.

12. The method of claim 1, said plurality of real rental properties comprising a preselected subset of a database of properties selected based upon geographic location.

13. The method of claim 1, further comprising classifying any given property in said distribution into a default risk category, based on how much the score for said given property differs from an average or mean score of said aggregate.

14. The method of claim 13, wherein said classifying is based on said given property's score's statistical standard deviation or variance with respect to said distribution.

15. The method of claim 13, wherein said classifying is based on a predetermined numeric difference of said given property's score from said average or mean score of said aggregate, with respect to said distribution.

16. The method of claim 1, further comprising calculating the property gauge score for said given real rental property at least two different times separated by predetermined time differences, resulting in at least two historically-separated property gauge scores for said given real rental property; and
further determining said default risk for said given real rental property by comparing said at least two historically-separated property gauge scores to one another.

17. The method of claim 1, further comprising conducting an onsite property management audit and review to identify operational and physical issues that underlie property performance for said given property, based said determining said default risk.

18. The method of claim 1, further comprising:
for a given property determined to have a default risk because its rent per square foot is substantially below market by a predetermined threshold, intervening with a manager of said given property to improve management performance; and
for a given property determined to have a default risk because its rent per square foot is substantially above market by a predetermined threshold, monitoring at least one of the market and the property for at least one of rent level changes and vacancies.

19. A computerized system for determining a default risk for a given real rental property, comprising a user interface and requisite computerized processing and computerized storage for:
providing computerized property data for a plurality of real rental properties including said given real rental property, said computerized property data comprising at least a rental price and a square footage for each said real rental property in said plurality of real rental properties including said given real rental property;
calculating a rent per square foot for each of said plurality of real rental properties, including said given real rental property;
calculating a property gauge score for each real rental property in said plurality of real rental properties, by comparing the rent per square foot for each said real rental property in said plurality of real rental properties to a rent per square foot of an aggregate including the other real rental properties in said plurality of real rental properties; and
determining said default risk for said given real rental property by comparing the property gauge score for said given real rental property to the property gauge scores for said remaining real rental properties in said plurality of real rental properties.

20. The system of claim 19, wherein said rent per square foot is an adjusted rent per square foot which is calculated to adjust for at least one of: rent adjustment factors; unit amenity adjustment factors; and property amenity adjustment factors.

21. The system of claim 19, wherein said property gauge score for said given real rental property is proportional to a ratio of said rent per square foot for said given real rental property, over said rent per square foot of said aggregate of said other real rental properties in said plurality of real rental properties.

22. The system of claim 21, wherein said property gauge score, denoted by PGS, is given by:
$$PGS = \frac{R}{A} \times \frac{1}{2} S ,$$
where R denotes a rent per square foot for said given property, A denotes an aggregate average or mean rent for all of said plurality of real rental properties, and S denotes an overall scale on which said property is to be scored.

23. The system of claim 20, wherein said property gauge score for said given real rental property is proportional to a ratio of the adjusted rent per square foot for said given real rental property, over the adjusted rent per square foot of said aggregate of said other real rental properties in said plurality of real rental properties.

24. The system of claim 23, wherein said property gauge score, denoted by PGS, is given by:
$$PGS = \frac{R}{A} \times \frac{1}{2} S ,$$
where R denotes a rent per square foot for said given property, A denotes an aggregate average or mean rent for all of said plurality of real rental properties, and S denotes an overall scale on which said property is to be scored; and wherein
said R comprises said adjusted rent per square foot and said A comprises said adjusted rent per square foot of said aggregate.

25. The system of claim 20, said computerized property data further comprising said rent adjustment factors comprising at least one of: rental discounts, if any; electrical service included in said rental price, if any; cable television service included in said rental price, if any; water service included in said rental price, if any; heat service included in said rental price, if any; cooking gas service included in said rental price, if any; internet service included in said rental price, if any; and garbage removal service included in said rental price, if any; wherein:
said rent per square foot is an adjusted rent per square foot which is calculated to adjust for said rent adjustment factors.

26. The system of claim 20, said computerized property data further comprising said unit amenity adjustment factors comprising at least one of: a dishwasher included in said rental price, if any; a microwave included in said rental price, if any; a washer/dryer included in said rental price, if any; a garage included in said rental price, if any; window coverings included in said rental price, if any; a fireplace included in said rental price, if any; vaulted ceilings included in said rental price, if any; a skylight included in said rental price, if any; bay windows included in said rental price, if any; granite countertops included in said rental price, if any; and an air conditioner included in said rental price, if any; wherein:
said rent per square foot is an adjusted rent per square foot which is calculated to adjust for said unit amenity adjustment factors.

27. The system of claim 20, said computerized property data further comprising said property amenity adjustment factors comprising at least one of: a clubhouse included in said rental price, if any; a laundry room included in said rental price, if any; a fitness center included in said rental price, if any; a pool included in said rental price, if any; sports activities included in said rental price, if any; a playground included in said rental price, if any; an elevator included in said rental price, if any; a concierge included in said rental price, if any; a business center included in said rental price, if any; and security service included in said rental price, if any; wherein:
said rent per square foot is an adjusted rent per square foot which is calculated to adjust for said property amenity adjustment factors.

28. The system of claim 20, wherein for at least one property in said plurality of real rental properties, said adjusted rent per square foot is equal to said rent per square foot with an adjustment equal to zero.

29. The system of claim 19, said computerized property data further comprising unit status factors comprising at least one of: an age of said real rental property; a repair state of said real rental property; a floor plan of said real rental property.

30. The system of claim 19, said plurality of real rental properties comprising a preselected subset of a database of properties selected based upon geographic location.

31. The system of claim 19, further comprising classifying any given property in said distribution into a default risk category, based on how much the score for said given property differs from an average or mean score of said aggregate.

32. The system of claim 31, wherein said classifying is based on said given property's score's statistical standard deviation or variance with respect to said distribution.

33. The system of claim 31, wherein said classifying is based on a predetermined numeric difference of said given property's score from said average or mean score of said aggregate, with respect to said distribution.

34. The system of claim 19, further comprising calculating the property gauge score for said given real rental property at least two different times separated by predetermined time differences, resulting in at least two historically-separated property gauge scores for said given real rental property; and
further determining said default risk for said given real rental property by comparing said at least two historically-separated property gauge scores to one another.

35. The system of claim 19, further comprising conducting an onsite property management audit and review to identify operational and physical issues that underlie property performance for said given property, based said determining said default risk.

36. The system of claim 19, further comprising:
for a given property determined to have a default risk because its rent per square foot is substantially below market by a predetermined threshold, intervening with a manager of said given property to improve management performance; and
for a given property determined to have a default risk because its rent per square foot is substantially above market by a predetermined threshold, monitoring at least one of the market and the property for at least one of rent level changes and vacancies.

37. A Property Gauge™ score product-by-process characterizing a default risk for a given real rental property, said Property Gauge™ score produced by a computerized method for determining a default risk for a given real rental property, said computerized method comprising:
providing computerized property data for a plurality of real rental properties including said given real rental property, said computerized property data comprising at least a rental price and a square footage for each said real rental property in said plurality of real rental properties including said given real rental property; and
via a user interface and requisite computerized processing and computerized storage:
calculating a rent per square foot for each of said plurality of real rental properties, including said given real rental property;
calculating a property gauge score for each real rental property in said plurality of real rental properties, by comparing the rent per square foot for each said real rental property in said plurality of real rental properties to a rent per square foot of an aggregate including the other real rental properties in said plurality of real rental properties; and
determining said default risk for said given real rental property by comparing the property gauge score for said given real rental property to the property gauge scores for said remaining real rental properties in said plurality of real rental properties.

38. The Property Gauge™ score of claim 37, wherein said rent per square foot is an adjusted rent per square foot which is calculated to adjust for at least one of: rent adjustment factors; unit amenity adjustment factors; and property amenity adjustment factors.

39. The Property Gauge™ score of claim 37, wherein said property gauge score for said given real rental property is proportional to a ratio of said rent per square foot for said given real rental property, over said rent per square foot of said aggregate of said other real rental properties in said plurality of real rental properties.

40. The Property Gauge™ score of claim 39, wherein said property gauge score, denoted by PGS, is given by:
$$PGS = \frac{R}{A} \times \frac{1}{2} S ,$$
where R denotes a rent per square foot for said given property, A denotes an aggregate average or mean rent for all of said plurality of real rental properties, and S denotes an overall scale on which said property is to be scored.

41. The Property Gauge™ score of claim 38, wherein said property gauge score for said given real rental property is proportional to a ratio of the adjusted rent per square foot for said given real rental property, over the adjusted rent per square foot of said aggregate of said other real rental properties in said plurality of real rental properties.

42. The Property Gauge™ score of claim 41, wherein said property gauge score, denoted by PGS, is given by:
$$PGS = \frac{R}{A} \times \frac{1}{2} S ,$$
where R denotes a rent per square foot for said given property, A denotes an aggregate average or mean rent for all of said plurality of real rental properties, and S denotes an overall scale on which said property is to be scored; and wherein
said R comprises said adjusted rent per square foot and said A comprises said adjusted rent per square foot of said aggregate.

43. The Property Gauge™ score of claim 38, said computerized property data further comprising said rent adjustment factors comprising at least one of: rental discounts, if any; electrical service included in said rental price, if any; cable television service included in said rental price, if any; water service included in said rental price, if any; heat service included in said rental price, if any; cooking gas service included in said rental price, if any; internet service included in said rental price, if any; and garbage removal service included in said rental price, if any; wherein:
said rent per square foot is an adjusted rent per square foot which is calculated to adjust for said rent adjustment factors.

44. The Property Gauge™ score of claim 38, said computerized property data further comprising said unit amenity adjustment factors comprising at least one of: a dishwasher included in said rental price, if any; a microwave included in said rental price, if any; a washer/dryer included in said rental price, if any; a garage included in said rental price, if any; window coverings included in said rental price, if any; a fireplace included in said rental price, if any; vaulted ceilings included in said rental price, if any; a skylight included in said rental price, if any; bay windows included in said rental price, if any; granite countertops included in said rental price, if any; and an air conditioner included in said rental price, if any; wherein:
said rent per square foot is an adjusted rent per square foot which is calculated to adjust for said unit amenity adjustment factors.

45. The Property Gauge™ score of claim 38, said computerized property data further comprising said property amenity adjustment factors comprising at least one of: a clubhouse included in said rental price, if any; a laundry room included in said rental price, if any; a fitness center included in said rental price, if any; a pool included in said rental price, if any; sports activities included in said rental price, if any; a playground included in said rental price, if any; an elevator included in said rental price, if any; a concierge included in said rental price, if any; a business center included in said rental price, if any; and security service included in said rental price, if any; wherein:
said rent per square foot is an adjusted rent per square foot which is calculated to adjust for said property amenity adjustment factors.

46. The Property Gauge™ score of claim 38, wherein for at least one property in said plurality of real rental properties, said adjusted rent per square foot is equal to said rent per square foot with an adjustment equal to zero.

47. The Property Gauge™ score of claim 37, said computerized property data further comprising unit status factors comprising at least one of: an age of said real rental property; a repair state of said real rental property; a floor plan of said real rental property.

48. The Property Gauge™ score of claim 37, said plurality of real rental properties comprising a preselected subset of a database of properties selected based upon geographic location.

49. The Property Gauge™ score of claim 37, further comprising any given property in said distribution classified by said computerized method into a default risk category, based on how much the score for said given property differs from an average or mean score of said aggregate.

50. The Property Gauge™ score of claim 49, wherein said classifying is based on said given property's score's statistical standard deviation or variance with respect to said distribution.

51. The Property Gauge™ score of claim 49, wherein said classifying is based on a predetermined numeric difference of said given property's score from said average or mean score of said aggregate, with respect to said distribution.

52. The Property Gauge™ score of claim 37, further comprising said computerized method calculating the property gauge score for said given real rental property at least two different times separated by predetermined time differences, resulting in at least two historically-separated property gauge scores for said given real rental property; and
further determining said default risk for said given real rental property by comparing said at least two historically-separated property gauge scores to one another.

53. The Property Gauge™ score of claim 37, further comprising conducting an onsite property management audit and review to identify operational and physical issues that underlie property performance for said given property, based on said default risk characterized by said Property Gauge™ score.

54. The Property Gauge™ score of claim 37, further comprising:
for a given property determined through said Property Gauge™ score to have a default risk because its rent per square foot is substantially below market by a predetermined threshold, intervening with a manager of said given property to improve management performance; and
for a given property determined through said Property Gauge™ score to have a default risk because its rent per square foot is substantially above market by a predetermined threshold, monitoring at least one of the market and the property for at least one of rent level changes and vacancies.
